(19) United States
(12) Patent Application Publication
(10) Pub. No.: US 2003/0049114 A1
(43) Pub. Date: Mar. 13, 2003

(54) Hitch

(76) Inventor: Joseph A. Gerdelmann III, Mt. Holly, NJ (US)

Correspondence Address: James G. O'Boyle, 711 Chevy Chase Building, 5530 Wisconsin Avenue, Chevy Chase, MD, 20815, US

(21) Appl. No.: 09/950,608

(22) Filed: Sep. 13, 2001

(51) Int. Cl. B66C 1/00

(52) U.S. Cl. 414/563

(57) ABSTRACT

A hitch for a tow truck of the type having towing apparatus including a cross beam connected to the distal end of a telescopic boom mounted on the rear of the tow truck chassis. The hitch has a base plate having depending side plates which straddle the telescopic boom and aligned cut-out portions in the side plates providing a saddle for receiving the cross beam. A tow bar connector, such as a tubular socket, having a handle secured to the top surface of the base plate. The hitch is manually positioned on the telescopic boom and cross beam and clamped between the cross beam and rear chassis of the tow truck when the telescopic boom is moved to the retracted position.

### BACKGROUND OF THE INVENTION:

Various hitches have been proposed for towing vehicles wherein the hitch having either a ball or socket, adapted to be connected to the end of a tow bar of a vehicle being towed, is permanently connected to the bumper or chassis of the towing vehicle.

Tow trucks are provided for towing motor vehicles wherein the front wheels of the vehicle being towed are positioned in a cradle connected to a transverse beam mounted on the distal end of a telescopic boom extending from the back of the tow truck.

There are times when there is need for this type of tow truck to tow vehicles having no front wheels, such as a trailer.

After considerable research and experimentation, the hitch of the present invention has been devised to be removably connected to the transverse beam of a tow truck, whereby the tow truck is adapted to selectively not only tow a motor vehicle in a conventional manner, but also to tow a vehicle such as a trailer.

### SUMMARY OF THE INVENTION

The hitch of the present invention comprises, essentially, a connectors such as a tubular socket, integral with a saddle portion adapted to be supported on the transverse beam mounted on the distal end of a telescopic boom extending from the back of a tow truck. A handle is integral with the connector portion of the hitch to facilitate the manual placing of the hitch on the transverse beam; after which, the boom is retracted to draw the transverse beam against the back of the truck, whereby the saddle portion is clamped between the transverse beam and the end of the truck, A removable safety pin extends through the hitch and the telescopic boom to prevent the unintentional removal of the hitch,

### BRIEF DESCRIPTION OF THE DRAWINGS

FIG. 1 is a perspective view showing the front end portion of the hitch of the present invention;

FIG. 2 is a perspective view of the hitch illustrated in FIG. 1 showing the rear portion thereof;

FIG. 3 is a perspective view of a tow truck towing apparatus showing the telescopic boom and associated transverse beam in the extended position preparatory to receiving the hitch of the present invention;

FIG. 4 is a perspective view showing the hitch of the present invention mounted on the telescopic boom and transverse beam and clamped between the truck frame and transverse beam.

### DESCRIPTION OF THE PREFERRED EMBODIMENT

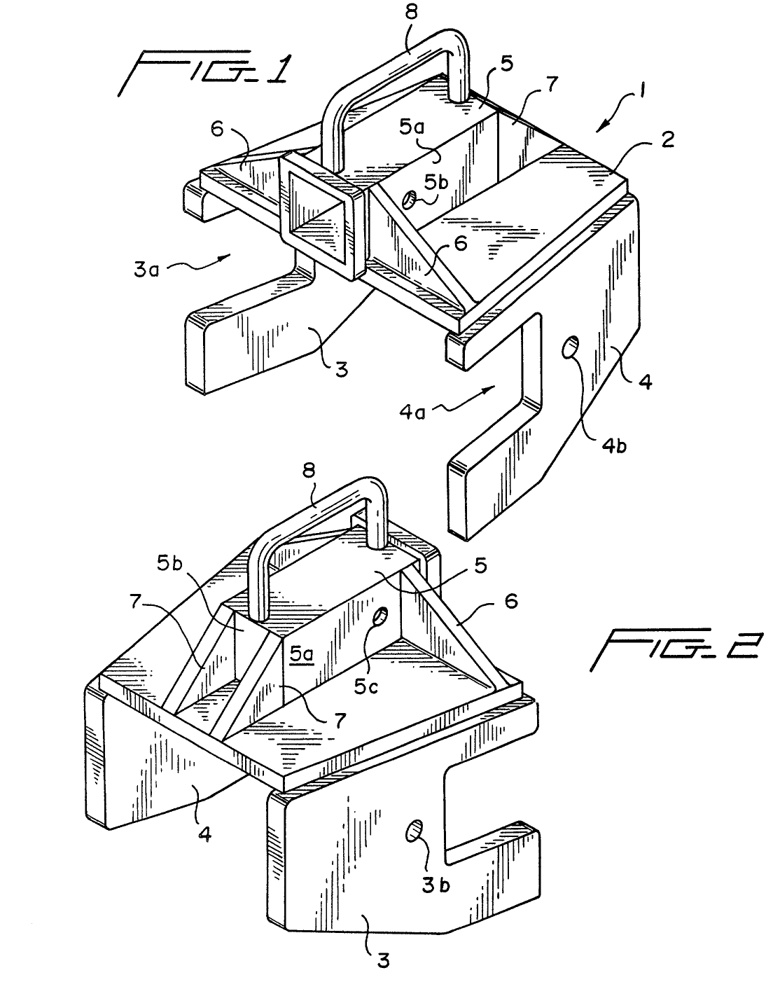

Referring to the drawings and more particularly to FIGS. 1 and 2, the hitch 1 of the present invention comprises a base plate 2 having a pair of integral depending side plates 3 and 4, each of which is provided with a rectangular cut-out portion 2a, 3a, respectively, to thereby provide a saddle portion for the hitch.

A tow bar connector 5 is integral with the top surface of the base plate 2, and consists of a tubular socket member having a rectangular cross section. The connector 5 is reinforced on the base plate 2 by a pair of transversely extending gusset plates 6, integral with the sides 5a of the connector 5 and the base plate 2; and a pair of longitudinally extending gusset plates 7 integral with the rear wall 5b of the connector and the base plate 2.

A handle 8 is secured to the connector for the manual manipulation of the hitch 1, and a pair of aligned apertures 3b and 4b are provided in the side plates 3 and 4, and a pair of aligned apertures 5b and 5c are provided in the sides 5a of the connector.

The aligned apertures 3b, 4b and 5b, 5c are adapted to receive removable safety pins when connected to the tow truck and tow bar, to be described more fully hereinafter.

While a socket-type connector 5 is illustrated, it will be appreciated by those skilled in the art that a conventional ball-type connector could also be secured to the top surface of the base plate 2 in lieu of the socket type connector.

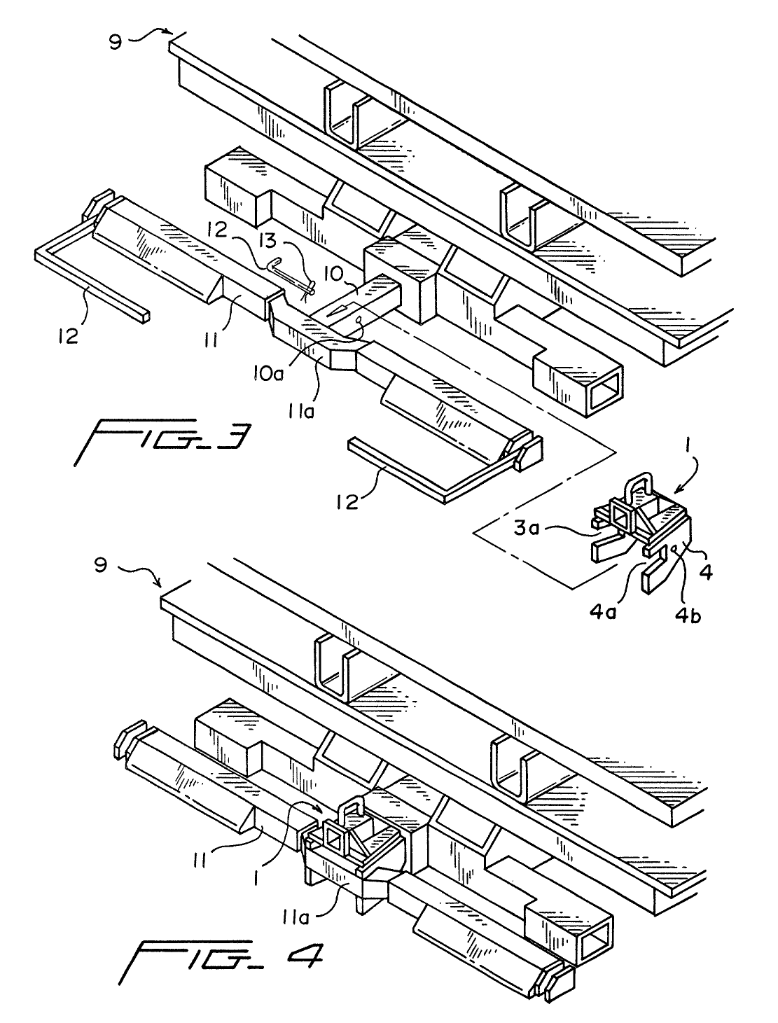

Referring to FIGS. 3 and 4, there is illustrated the rear end of a conventional tow truck 9 of the type having an extendable and rectractable telescopic boom member 10 provided with a cross beam 11 on the distal end thereof. The outboard ends of the cross beam 11 are typically provided with removable cradle members 12 for supporting the front wheels of a motor vehicle to be towed.

There are times when it is desired to employ the tow truck 9 for towing other types of vehicles other than motor vehicles, such as trailers having a tow bar. The hitch 1 of the present invention facilitates the towing of such vehicles. To this end, the telescopic boom 10 and associated cross beam 11 are moved to the extended position, as shown in FIG. 3, and the hitch 1 is placed on the telescopic boom 10 with the side walls 3 and 4 of the hitch 1 straddling the telescopic boom 10 and the openings 3a, 4a in the hitch side plates 3 and 4, straddling the medial portion 11a of the cross beam 11.

The telescopic boom 10 and associated cross beam 11 are then moved to the retracted position, as shown in FIG. 4, to thereby clamp the hitch 1 between the medial portion 11a of the cross beam 11 and the tow truck chassis. To further secure the hitch 1 in the operative position, a safety pin 12 and cooperating clip 13 are provided, the pin extending between the aligned apertures 3b, 4b in the side walls 3 and 4 of the hitch and aligned apertures 10a in the sidewalls of the telescopic boom 10.

A suitable safety pin, not shown, could also be employed for extending through the aligned apertures 5b, 5c in the side walls 5a of the hitch and the tongue of a tow bar inserted with the socket portion of the hitch.

From the above description, it will be appreciated by those skilled in the art that the hitch of the present invention enhances the utility of extensible and retractable cross beam type tow trucks in that the tow truck can be easily and quickly converted to a tow truck for towing trailer-type vehicles; that the hitch is simple and inexpensive to manufacture; it is rugged and therefore not likely to get out of order even after long and continued use.

It is understood that the form of the invention herewith shown and described is to be taken as a preferred example of the same, and that various changes in the shape, size and arrangement of parts may be resorted to, without departing from, the spirit of the invention or scope of the subjoined claims.

I claim:

1. A hitch for a tow truck of the type having a cross beam connected to the distal end of a telescopic boom mounted in the rear chassis of a tow truck, comprising a base plate having a top surface and side edge portions, a pair of side plates, said side plates being laterally spaced and integral with said side edge portions of said base plate and depending therefrom, said side plates adapted to straddle the telescopic boom, aligned cutout portions in said side plates providing a saddle adapted to receive said cross beam, and a tow bar connector mounted on the top surface of the base plate, whereby the hitch is adapted to be manually placed on the telescopic boom and cross beam, and clamped between the cross beam and tow truck chassis when the telescopic boom is moved to the retracted position.

2. A hitch, according to claim 1, wherein a handle is mounted on said tow bar connector.

3. A hitch, according to claim 1, wherein aligned apertures are provided in said side plates and a safety pin adapted to extend through said aligned apertures and said telescopic boom.

4. A hitch, according to claim 1, wherein the tow bar connector comprises a tubular socket mounted on the top surface of said base plate.

5. A hitch, according to claim 3, wherein gusset plates extend between the tubular socket and top surface of the base plate.
